(19) United States
(12) Patent Application Publication
(10) Pub. No.: US 2008/0088815 A1
(43) Pub. Date: Apr. 17, 2008

(54) POLARIZATION OPTICAL SYSTEM

(76) Inventor: Hiroshi NOMURA, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/872,285

(22) Filed: Oct. 15, 2007

(30) Foreign Application Priority Data
Oct. 16, 2006 (JP) 2006-281629

(51) Int. Cl. G03B 27/54; G02B 27/28

(52) U.S. Cl. 355/71; 359/495

(57) ABSTRACT

The polarization optical system includes a polarization beam splitter that divides incident light into two divided light beams having polarization directions orthogonal to each other. A combination optical system changes the optical axis of one of the two divided light beams back to the same optical axis as the other divided light beam and combines the divided light beams on the axis. A half-wave plate is disposed in the optical axis of one of the two divided light beams.

### CROSS REFERENCE TO RELATED APPLICATIONS

This application is based on and claims the benefit of priority from prior Japanese Patent Application No. 2006-281629, filed on Oct. 16, 2006, the entire contents of which are incorporated herein by reference.

### BACKGROUND OF THE INVENTION

1. Field of the Invention

The present invention relates to a polarization optical system, and more particularly, to a polarization optical system for use in a semiconductor exposure system.

2. Description of the Related Art

Exposure systems have been commonly used to expose circuit patterns of semiconductor devices or liquid crystal displays. The exposure systems perform a lithography process in which the original-plate pattern formed on the photomask is reduced and transferred to the substrate.

With a request for smaller semiconductor devices, the resolution has been increased by a light source having a shorter wavelength and a projection optical system having a larger diameter. An exposure system having NA of 0.9 or more using the ArF excimer laser of a wavelength of 193 nm is brought from a development stage to practical use stage. Also developed are the ArF immersion exposure system and the F2 exposure system. The ArF immersion exposure system has an NA of 1.0 or more with liquid filled between the lowest lens of the protection optical system and the substrate. The F2 exposure system uses the F2 excimer laser having a wavelength of 157 nm. The F2 immersion exposure system is also proposed.

The larger NA causes a problem that the polarization state of the illumination light contributes to the reduction of the resolution, which is not a problem for the smaller NA. It is thus attempted to limit the resolution reduction due to the polarization state by developing an exposure system than controls the polarization state or allows measurement of the polarization state (see, for example, JP 2005-116732).

The polarized-light illumination optical system should have the polarization state and the distribution of the polarization state that are desired by the designer. The polarized-light illumination optical system should also provide the least loss of light intensity. The fewest possible linear polarizers are thus used therein. Instead, phase retarders such as a half-wave plate and a quarter-wave plate are frequently used. It is important that the phase retarders control the polarization state of the incident light with the light kept in good polarization state or good polarization degree.

The argon fluoride excimer laser for use in the immersion exposure system generally emits high-quality horizontal linearly polarized light. An optical system is therefore needed to guide light, while keeping the high-quality polarization, from the exit aperture of the laser source to the entrance aperture of the illumination optical system. Mirrors used in the guide optical system change the polarization state of the light depending on how the mirrors change the light direction and the mirror materials. The mirrors thus largely limit the layouts of the laser system and the exposure system and the like. This may adversely and seriously affect the manufacturing cost by, for example, requiring a larger footprint in the clean room.

The elliptical polarization may generally be converted into any linear polarization using a combined optical system of a quarter-wave elate and a half-wave plate. The fast axis of the quarter-wave plate is aligned with the azimuth of the elliptical polarization. The elliptical polarization is thus converted to linear polarization having an azimuth corresponding to a diagonal of a rectangle circumscribed about the ellipse. The half-wave plate may then be used to convert the azimuth of the linear polarization to a desired value. This is done by setting the azimuth of the half-wave plate to the midpoint between the desired azimuth of the linear polarization and the azimuth of the linear polarization before conversion. The above conversion method will provide little loss or intensity. By incorporating the above optical system into the entrance aperture of the illumination optical system of the exposure system, therefore, it is entirely possible to restore the polarization state that changes as light passes through the guide optical system to the desired linear polarization.

To do so, however, it is necessary to accurately measure the azimuth and the ellipticity of the elliptical polarization and use the measurement to accurately align the azimuths of the ¼- and half-wave plates. Because of much effort and cost for these operations, it is very hard to increase the degree or freedom of the guide optical system.

### SUMMARY OF THE INVENTION

A polarization optical system according to an aspect of the present invention comprises a polarization beam splitter that divides incident light into two divided light beams having polarization directions orthogonal to each other; a combination optical system that changes an optical axis of one of the to divided light beams back to the same optical axis as the other divided light beam and combines the divided light beams on the axis; and a half-wave plate disposed in the optical axis of one of the two divided light beams.

### BRIEF DESCRIPTION OF THE DRAWINGS

FIG. 1 shows a configuration of a polarization optical system according to a first embodiment of the present invention.

FIG. 2 shows an example configuration of an exposure system including a polarization optical system of the first embodiment.

FIG. 3 shows a modification of the first embodiment,

FIG. 4 shows a configuration of a polarization optical system according to a second embodiment of the present invention.

FIG. 5 shows a configuration of a polarization optical system according to a third embodiment of the present invention.

FIG. 6 shows a conventional polarization optical system.

### DETAILED DESCRIPTION OF THE EMBODIMENTS

With reference to the accompanying drawings, preferred embodiments of the present invention will now he described in detail.,

### First Embodiment

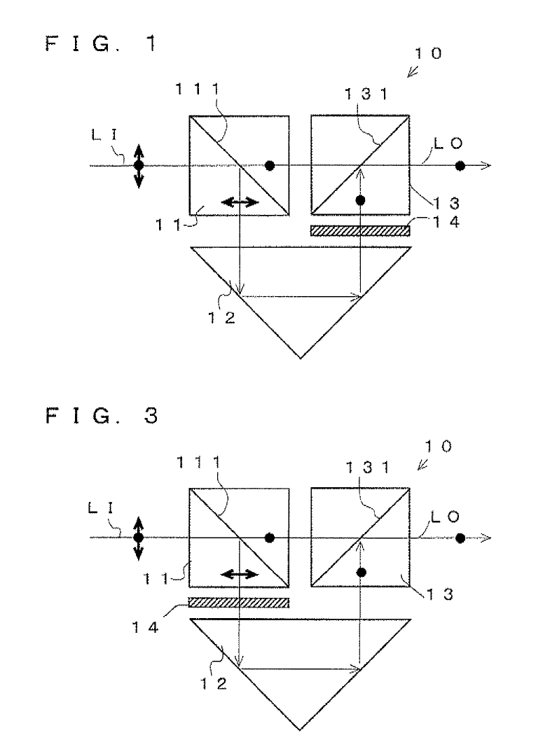

Referring to FIG. 1, a configuration of a polarization optical, system 10 according to a first embodiment of the present invention will now be described. The polarization optical system 10 includes a polarization beam splitter 11, a reflection prism 12, a non-polarizing combination prism 13, and a half-wave plate 14, The polarization optical system 10 has a function of converting incident light LI having various polarization components into light having a desired polarization direction such as horizontal linearly polarized light and emitting the light as emitted light LO.

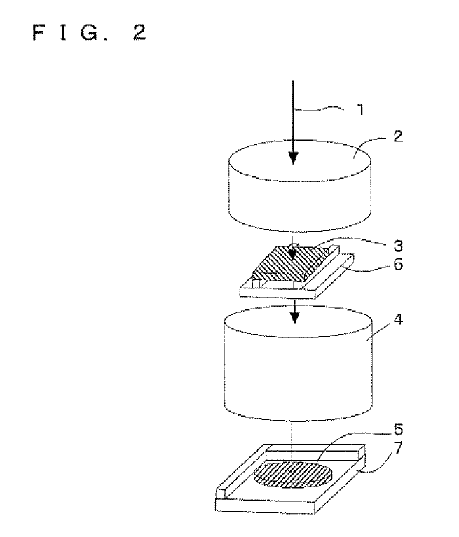

FIG. 2 schematically shows an example configuration of an exposure system including the polarization optical system 10. Referring to FIG. 1, the exposure system works as follows. Illumination light 1 from a not-shown light source (e.g., an argon fluoride excimer laser source having a wavelength of approximately 193 nm) is converted by and illumination optical system 2 into light having desired brightness distribution and polarization state. The converted light is then illuminated to a photomask 3 supported by a photomask stage 6. Light passing through the photomask 3 is projected through a projection lens 4 onto a wafer 5 coated with a light-sensitive film. The pattern of the photomask 3 is transferred to the wafer 5. The wafer 5 is mounted on a wafer stage 7. The polarization optical system 10 in FIG. 1 is incorporated in the illumination optical system 2. The system 10 has a function of restoring the polarization state of light having changed as the light is guided, to the desired polarization state.

Returning to FIG. 1, the elements 11 to 14 of the polarization optical element will be described. The polarization beam splitter 11 has a function of dividing on a reflective surface 111, the incident light LI having various polarization components into two divided light beams (vertical linearly polarized light and horizontal linearly polarized light). The two divided light beams have polarization directions orthogonal to each other.

The reflection prism 12 has a function of changing the direction of the optical axis of one (vertical linearly polarized light) of the light beams. The non-polarizing combination prism 13 includes a reflective surface 131. The surface 131 transmits light that passes through the polarization beam splitter 11. The surface 131 reflects light that is reflected by the polarization beam splitter 11 and is guided by the reflection prism 12. The non-polarizing combination prism 13 thus has a function of returning the two light beams to the same optical axis and combining them on the axis.

The half--wave plate 14 resides in the optical path of light that is reflected by the reflective surface 111 of the polarization beam splitter 11. The plate 14 resides, for example, between the reflection prism 12 and the non-polarizing combination prism 13, as shown in FIG. 1 (alternatively, the plate 14 may reside between the polarization beam splitter 11 and the reflection prism 12, as shown in FIG. 3). The half-wave plate 14 has a function of converting vertical linearly polarized light into horizontal linearly polarized light that has a different polarization direction from the vertical polarized light by 90 degrees. The half-wave plate 14 is disposed to have an azimuth of 45 degrees with respect to the polarization direction of the vertical linearly-polarized light that is incident on the plate 14. The azimuth of the half-wave plate 14 may be set independently of the polarization components of the incident light LI. The azimuth may thus be adjusted easily.

After conversion by the half-wave plate 14, the horizontal linearly-polarized light is combined, by the non-polarizing combination prism 13, with horizontal linearly-polarized light that passes through the polarization beam splitter 11. The combined light is then emitted as horizontal linearly-polarized light (the emitted light LI).

The effect of the polarization optical system 10 of this embodiment is now described.

There are generally two ways to provide light having a desired polarization direction. The first way is to use a linear polarizer. This way discards a polarization component perpendicular to the transmission axis of the polarizer. A loss of light intensity thus occurs accordingly.

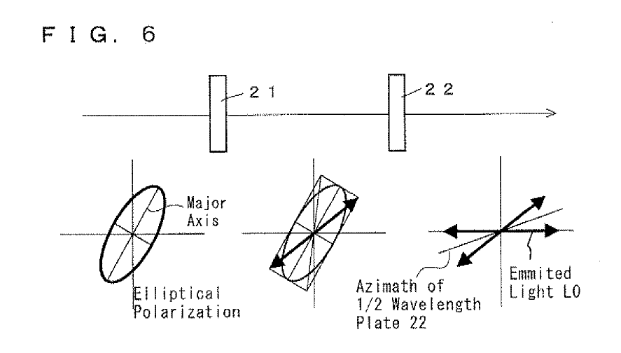

The second way is to use a combined optical system of a quarter-wave plate 21 and a half-wave plate 22, as shown in FIG. 6. Referring to FIG. 6, when incident light has elliptical polarization, the fast axis of the quarter-wave plate 21 is aligned with the azimuth of the elliptical polarization. The elliptical polarization is thus converted to linear polarization Lm having an azimuth corresponding to a diagonal of a rectangle circumscribed about the ellipse. The azimuth of the half-wave plate 22 is then set to the midpoint between the azimuth of the desired linear polarization of the emitted light LO and the azimuth of the linear polarization Lm before conversion. The azimuth of the linear polarization of the emitted light LO may thus be converted to the desired azimuth. The above way will cause little loss of light intensity.

It is,, however, difficult to determine the azimuths of the ¼- and half-wave plates 21 and 22. First, while a not-shown linear polarizer is rotated by 360 degrees, the intensity of the transmitted light is measured. The intensity variation is then used to determine the azimuthal angle of the elliptical polarization. The azimuth of the fast axis of the quarter-wave plate 21 is aligned with the azimuthal angle. The elliptical polarization is thus converted to a linear polarization having an azimuth in the diagonal direction of the rectangle that is circumscribed about the ellipse. The rectangle has two diagonals. The elliptical polarization is converted to one of them depending on the polarity of the elliptical polarization, i.e., whether the polarization is clockwise or counterclockwise.

The above measurement method cannot determine the polarity of the elliptical polarization. It is thus necessary, again, that while the linear polarizer is rotated by 360 degrees, the intensity of the transmitted light be measured, and the intensity variation be used to determine the azimuth of the linear polarization. The polarization azimuth is then used to determine the azimuth of the half-wave plate 22. In this way, a complicated polarization analysis is necessary to convert the elliptical polarization to the linear polarization with a small loss of intensity. In the method in FIG. 6, therefore, the adjustment is complicated and an automated adjustment is difficult to achieve.

On the other hand, the polarization optical system 10 in this embodiment does not use the linear polarizer. The system 10 may thus extract light having a desired polarization component with a small loss of intensity of the emitted light. Further, it is not necessary to adjust the azimuth of the half-wave plate 14 depending on the degree of the polarization of the incident light LI. The desired polarization component may thus be extracted without any complicated adjustments.

### Second Embodiment

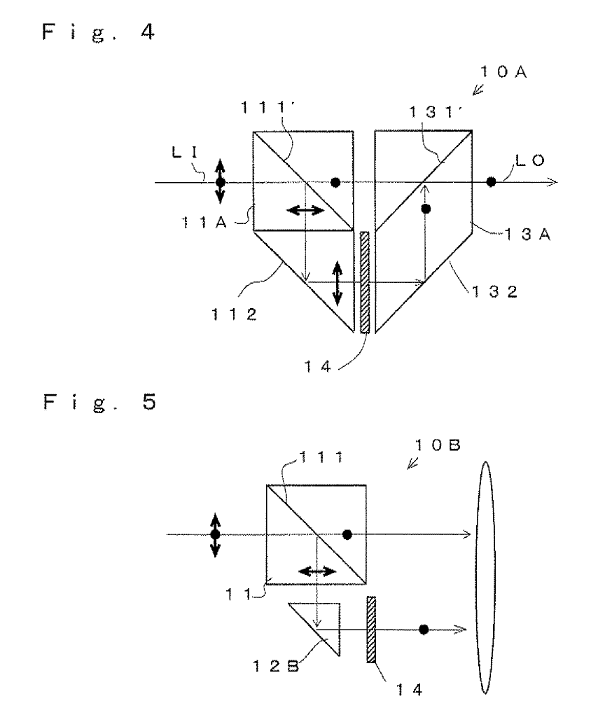

Referring to FIG. 4, a polarization optical system according to a second embodiment of the present invention is now described. A polarization optical system 10A in this embodiment includes a polarization beam splitter 11A, a non-polarizing combination prism 13A, and the half-wave plate 14. The polarization beam splitter 11A operates like the polarization beam splitter 11 in the first embodiment. Specifically, the splitter 11A has a function of dividing, on a reflective surface 111′ formed therein, the incident light LI having various polarization components into two divided light beams (vertical linearly-polarized light and horizontal linearly-polarized light). The two divided light beams have polarization directions orthogonal to each other. The vertical linear polarization component is reflected by the reflective surface 111′. The polarization beam splitter 11A has a trapezoid shape, and has on the oblique side a reflective surface 112 that changes the direction of the optical axis of the vertical linear polarization component. The reflective surface 12 is formed in generally parallel with the reflective surface 111′. The vertical linear polarization component that is emitted by the reflective surface 112 is thus emitted in generally parallel with the incident light LI.

The non-polarizing combination prism 13A includes a reflective surface 131′ formed therein. The prism 13A operates like the non-polarizing combination prism 13 in the first embodiment. Specifically, the surface 131′ transmits light (horizontal linear polarization component) that passes through the polarization beam splitter 11A. The surface 13′ also reflects light that is reflected by the polarization beam splitter 11A and is guided. The non-polarizing combination prism 13A thus has a function of returning the two light beams to the same optical axis and combining them on the axis. The non-polarizing combination prism 13A has a trapezoid shape, and has on the oblique side a reflective surface 132 that changes the direction of the optical axis of the light reflected by the reflective surface 112. The reflective surface 132 is formed in generally parallel with the reflective surface 131′. The reflective surface 131′ thus reflects light back to the same optical axis as the light passing through the splitter 11A. The optical path between the reflective surfaces 112 and 132 has therein the half-wave plate 14 as in the first embodiment. The half-wave plate 14 converts the vertical linear polarization component reflected by the reflective surface 112 to the horizontal linear-polarization component. The two light beams to be combined on the reflective surface 131′ thus both have the horizontal linear-polarization component. The emitted light LO then has only the horizontal linear-polarization component.

### Third Embodiment

Referring to FIG. 5, a polarization optical system 100 according to a third embodiment of the present invention is now described. The polarization optical system 10B in this embodiment includes, as in the first embodiment, the polarization beam splitter 11, a reflection prism 12B, and the half-wave plate 14. The system 10B also includes a light collection lens 15. The light collection lens 15 replaces the non-polarizing combination prism 13 in the first embodiment. Like the prism 13, the lens 15 has a function of combining two horizontal linear-polarization components. One horizontal linear polarization component passes through the polarization beam splitter 11. The other horizontal linear polarization component is reflected by the polarization beam splitter 11. The other polarization component is then reflected by the reflection prism 12B and passes through the half-wave plate 14.

Thus, although the invention has been described with respect to particular embodiments thereof, it is not limited to those embodiments. It will be understood that various modifications and additions and the like may be made without departing from the spirit of the present invention.

What is claimed is:

1. A polarization optical system comprising:
a polarization beam splitter that divides incident light into two divided light beams having polarization directions orthogonal to each other;
a combination optical, system that changes an optical axis of one of the two divided light beams back to the same optical axis as the other divided light beam and combines the divided light beams on the axis; and
a half-wave plate disposed in the optical axis of one of the two divided light beams.

2. The polarization optical system according to claim 1, wherein
the half-wave plate has an azimuth of 45 degrees with respect to an azimuth of linearly polarized light that passes through the half-wave plate.

3. The polarization optical system according to claim 1, wherein the incident light is argon fluoride excimer laser light having a wavelength of approximately 193 nm.

4. The polarization optical system according to claim 1, wherein
the combination optical system includes a non-polarizing combination prism.

5. The polarization optical system according to claim 1, further comprising a reflection optical system that guides one of the two divided light beams that passes through the polarization beam splitter to the combination optical system.

6. The polarization optical system according to claim 1, wherein
the polarization beam splitter has a trapezoid shape and includes a first reflective surface that divides incident light into two divided light beams, and a second reflective surface in generally parallel with the first reflective surface the second reflective surface being formed on an oblique side of the trapezoid shape.

7. The polarization optical system according to claim 6, wherein
the combination optical system is a non-polarizing combination prism having a trapezoid shape, the prism comprising:
a third reflective surface that reflects incident light, the third reflective surface being formed on an oblique side of the trapezoid shape; and
a fourth reflective surface that combines the two divided light beams, the fourth reflective surface being formed in the prism in generally parallel with the third reflective surface.

8. The polarization optical system according to claim 7, wherein
the half-wave plate is disposed between the second reflective surface and the third reflective surface.

9. The polarization optical sys tom according to claim 1, wherein
the combination optical system is a light collection lens.

10. An exposure system comprising:
a illumination optical system that converts a polarization state of illumination light into a desired polarization state;
a photomask stage to support a photomask; and
a projection optical system that projects light passing through the photomask onto a wafer, wherein
the illumination optical system comprises:
a polarization beam splitter that divides incident light into two divided light beams having polarization directions orthogonal to each other;
a combination optical system that changes an optical axis of one of the two divided light beams back to the same optical axis as the other divided light beam and combines the divided light beams on the axis; and
a half-wave plate disposed in the optical axis of one of the two divided light beams.

11. The exposure system according to claim 10, wherein
the half-wave plate has an azimuth of 45 degrees with respect to an azimuth of linearly polarized light that passes through the half-wave plate.

12. The exposures system according to claim 10, wherein the incident light is argon fluoride excimer laser light having a wavelength of approximately 193 nm.
